(19) United States
(12) Patent Application Publication
(10) Pub. No.: US 2017/0189992 A1
(43) Pub. Date: Jul. 6, 2017

(54) BLACK SUB-ANODIZED MARKING USING PICOSECOND BURSTS

(71) Applicant: nLIGHT, Inc., Vancouver, WA (US)

(72) Inventors: Adam Dittli, Vancouver, WA (US); Ken Gross, Vancouver, WA (US)

(73) Assignee: nLIGHT, Inc., Vancouver, WA (US)

(21) Appl. No.: 15/396,738

(22) Filed: Jan. 2, 2017

Related U.S. Application Data
(60) Provisional application No. 62/273,847, filed on Dec. 31, 2015.

(51) Int. Cl. B23K 26/0622; B23K 26/00; B23K 26/352; B41M 5/00; H01S 3/00; H01S 3/23; H01S 3/094; B41M 5/26; B23K 26/082; H01S 3/067

(52) U.S. Cl. CPC B23K 26/0624; B23K 26/082; B23K 26/0066; B23K 26/0006; B23K 26/352; H01S 3/067; H01S 3/0071; H01S 3/2308; H01S 3/094076; B41M 5/262; B41M 5/0058; B41M 5/0052; B23K 2203/166

(57) ABSTRACT

A method includes generating a plurality of pulse bursts with a predetermined quantity of intra-burst pulses in each pulse burst and a temporal spacing between the intra-burst pulses, and with a pulse burst frequency, and scanning the pulse bursts across an anodized target at a scan rate so that the pulse bursts overlap at the anodized target by an amount that is above an overlap damage threshold and the intra-burst pulses provide a peak power and peak fluence that are below an ablation threshold of the anodized target so as to produce a laser mark on the anodized target with an L value of less than or equal to 30 and without a damage to an anodized layer of the anodized target.

### CROSS REFERENCE TO RELATED APPLICATION

This application claims the benefit of U.S. Provisional Patent Application No. 62/273,847, filed Dec. 31, 2015, which is incorporated by reference herein in its entirety. This application is related to U.S. patent application Ser. No. 15/392,925, filed Dec. 28, 2016, which is incorporated by reference herein in its entirety.

### FIELD

The field relates to picosecond laser burst marking and material processing.

### BACKGROUND

It has been found that directing laser beams at objects of various material types can produce laser marks with various degrees of permanence and quality, and with various visual characteristics. Generally, marks with a darkness defined by an L value at or below 30 are preferred, though such marks are difficult or impossible to produce or are impractical for high volume manufacturing due to the lengthy duration of the laser process used to produce the marks. Therefore, a need remains for laser processes that can produce dark marks in a short amount of time.

### SUMMARY

In some examples of the disclosed technology, methods include generating a plurality of pulse bursts with a predetermined quantity of intra-burst pulses in each pulse burst and a temporal spacing between the intra-burst pulses, and with a pulse burst frequency, and scanning the pulse bursts across an anodized target at a scan rate so that the pulse bursts overlap at the anodized target by an amount that is above an overlap damage threshold and the intra-burst pulses provide a peak power and peak fluence that are below an ablation threshold of the anodized target so as to produce a laser mark on the anodized target with an L value of less than or equal to 30 and without a damage to an anodized layer of the anodized target. In some examples, the intra-burst pulse temporal spacing and intra-burst pulse quantity are selected so that an area of the laser mark in a direction of the scanning has an elongated shape. In some examples, pulsed fiber laser apparatuses are disclosed that use various methods described herein. In further examples, laser marked surfaces are disclosed that are formed using the various methods described herein.

The foregoing and other objects, features, and advantages of the disclosed technology will become more apparent from the following detailed description, which proceeds with reference to the accompanying figures.

### BRIEF DESCRIPTION OF THE DRAWINGS

FIG. 1 is a schematic of a laser marking system 100.

FIG. 2 is a flowchart of a laser marking method 200.

FIGS. 3A and 3B are graphs depicting laser pulse bursts.

FIG. 4 is an example of a laser mark created with pulsed laser bursts.

FIG. 5 is another example of a laser mark created with pulsed laser bursts.

### DETAILED DESCRIPTION

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In some examples, values, procedures, or apparatus' are referred to as “lowest”, “best”, “minimum,” or the like. It will be appreciated that such descriptions are intended to indicate that a selection among many used functional alternatives can be made, and such selections need not be better, smaller, or otherwise preferable to other selections.

As used herein, optical radiation refers to electromagnetic radiation at wavelengths of between about 100 nm and 10 μm, and typically between about 500 nm and 2 μm. Examples based on available laser diode sources and optical fibers generally are associated with wavelengths of between about 800 nm and 1700 nm. In some examples, propagating optical radiation is referred to as one or more beams or laser pulses having diameters, cross-sectional areas, and divergences that can depend on beam or pulse wavelength and the optical systems used for beam or pulse shaping. For convenience, optical radiation is referred to as light in some examples, and need not be at visible wavelengths. Series of optical pulses can form one or more beams. In some examples, optical wavelengths are changed with one or more non-linear optical processes, such as frequency doubling.

Representative embodiments are described with reference to optical fibers, but other types of optical waveguides can be used having square, rectangular, polygonal, oval, elliptical or other cross-sections. Optical fibers are typically formed of silica (glass) that is doped (or undoped) so as to provide predetermined refractive indices or refractive index differences. In some, examples, fibers or other waveguides are made of other materials such as fluorozirconates, fluoroaluminates, fluoride or phosphate glasses, chalcogenide glasses, or crystalline materials such as sapphire, depending on wavelengths of interest. Refractive indices of silica and fluoride glasses are typically about 1.5, but refractive indices of other materials such as chalcogenides can be 3 or more. In still other examples, optical fibers can be formed in part of plastics. In typical examples, a doped waveguide core such as a fiber core provides optical gain in response to pumping, and core and claddings are approximately concentric. In other examples, one or more of the core and claddings are decentered, and in some examples, core and cladding orientation and/or displacement vary along a waveguide length.

As used herein, numerical aperture (NA) refers to a largest angle of incidence with respect to a propagation axis defined by an optical waveguide for which propagating optical radiation is substantially confined. In optical fibers, fiber cores and fiber claddings can have associated NAs, typically defined by refractive index differences between a core and cladding layer, or adjacent cladding layers, respectively. While optical radiation propagating at such NAs is generally well confined, associated electromagnetic fields such as evanescent fields typically extend into an adjacent cladding layer. In some examples, a core NA is associated with a core/inner cladding refractive index, and a cladding NA is associated with an inner cladding/outer cladding refractive index difference. For an optical fiber having a core refractive index n_{core} and a cladding index n_{clad}, a fiber core NA is NA=\sqrt{n_{core}²−n_{clad}²}. For an optical fiber with an inner core and an outer core adjacent the inner core, a cladding NA is NA=\sqrt{nᵢₙₙₑᵣ²−nₒᵤₜₑᵣ²}, wherein nᵢₙₙₑᵣ and nₒᵤₜₑᵣ are refractive indices of the inner cladding and the outer cladding, respectively. Optical beams as discussed above can also be referred to as having a beam NA which is associated with a beam angular radius. While multi-core step index fibers are described below, gradient index designs can also be used.

In the examples disclosed herein, a waveguide core such as an optical fiber core is doped with a rare earth element such as Nd, Yb, Ho, Er, or other active dopants or combinations thereof. Such actively doped cores can provide optical gain in response to optical or other pumping. As disclosed below, waveguides having such active dopants can be used to form optical amplifiers, or, if provided with suitable optical feedback such as reflective layers, mirrors, Bragg gratings, or other feedback mechanisms, such waveguides can generate laser emissions. Optical pump radiation can be arranged to co-propagate and/or counter-propagate in the waveguide with respect to a propagation direction of an emitted laser beam or an amplified beam.

The term brightness is used herein to refer to optical beam power per unit area per solid angle. In some examples, optical beam power is provided with one or more laser diodes that produce beams whose solid angles are proportional to beam wavelength and beam area. Selection of beam area and beam solid angle can produce pump beams that couple selected pump beam powers into one or more core or cladding layers of double, triple, or other multi-clad optical fibers. Spatial and temporal characteristics of beams and pulses can be described using boundaries that generally correspond to a zero intensity value, a 1/e value, a 1/e² value, a full-width half-maximum (FWHM) value, or other suitable metric. Spatial and temporal characteristics of beams and pulses include but are not limited to pulse energy, pulse fluence, pulse duration, beam diameter, spot size, waist, pulse intensity, pulse power, irradiance, pulse overlap, pulse scan path overlap, etc. Various examples include threshold values above or below which desirable or undesirable changes occur to one or more layers of a material. Some embodiments include thresholds that are fixed or variable.

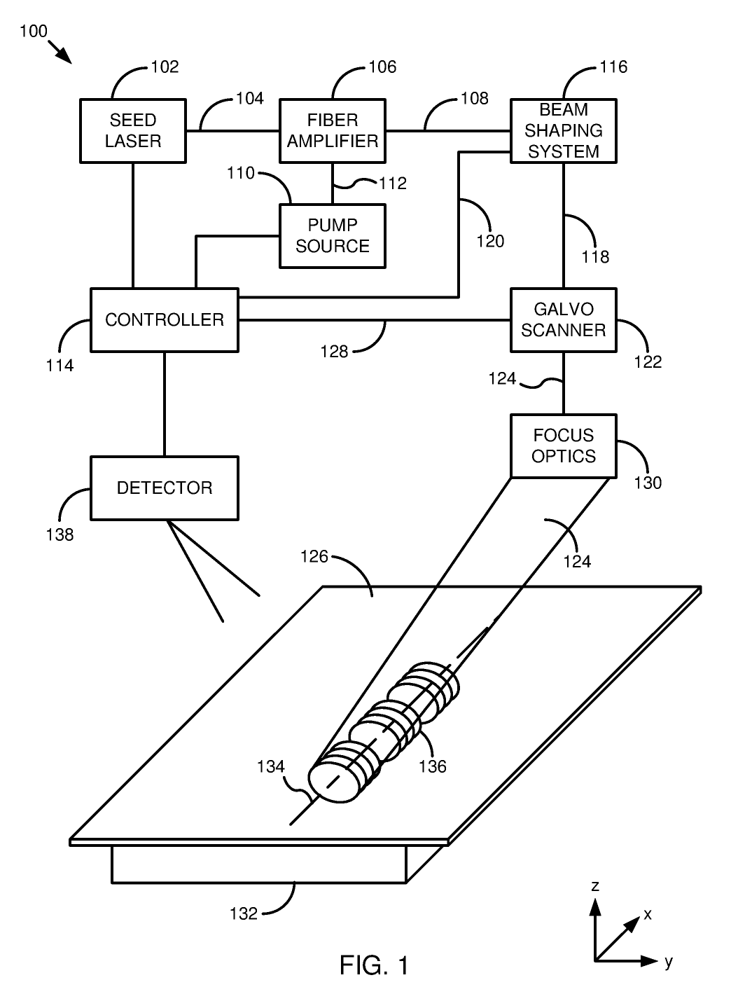

Referring to FIG. 1, a laser marking system 100 includes a seed laser 102 situated to generate seed laser pulse bursts 104 and a fiber amplifier 106 situated to receive the seed laser pulse bursts 104 and to produce amplified laser pulse bursts 108. In typical examples, the seed laser 102 and fiber amplifier 106 are situated in master oscillator fiber amplifier configuration and form a fiber laser system. Pulses can be frequency converted (e.g., with a nonlinear optical crystal) in some examples. A pump source 110 is optically coupled to the fiber amplifier 106 and provides it with one or more pump beams 112 at a pump wavelength for producing the amplified laser pulse bursts 108. A controller 114 is coupled to the seed laser 102 and the pump source 110 to control various characteristics of the amplified laser pulse bursts 108, such as pulse burst frequency, pulse burst duration, pulse duration, intra-burst pulse frequency, intra-burst pulse quantity, pulse power, etc. In some examples, a electrooptic modulator or acousto-optic modulator is part of the seed laser 102 or laser marking system 100 so as to control a pulse burst power or intra-burst pulse power. A beam shaping system 116 is situated to receive the amplified laser pulse bursts 108 and to adjust propagation characteristics of the amplified laser pulse bursts 108 to form shaped laser pulse bursts 118 based on a control signal received from the controller 114. In representative examples, the shaped laser pulse bursts are collimated to a selected diameter and have an approximately circular symmetric Gaussian intensity profile perpendicular to an optical axis propagation direction. In other examples, shaped laser pulse bursts can be convergent or divergent and have non-Gaussian intensity profiles, such as flat-top.

A galvo-scanner 122 is situated to receive the shaped laser pulse bursts 118 and to alter a propagation direction to produce laser processing bursts 124 that are directed to different locations on a target surface 126 based on a controller input 128. In some examples, the galvo-scanner 122 includes a pair of scan mirrors that separately rotate about a respective rotation axis so that a rotation of the first mirror directs the laser processing bursts 124 along a first direction perpendicular to a propagation direction and a rotation of the second mirror directs along a second direction mutually perpendicular to the first direction and the propagation direction. Focus optics 130, such as an F-theta lens, are situated to receive the laser processing bursts 124 for focusing at the target surface 126. A translation stage 132 can be coupled to the target surface 126 to vary an x, y, or z position of the target surface 126. In some examples, the translation stage 132, the focus optics 130, or beam shaping system 116 are operable to provide the laser processing bursts 124 at the target surface 126 at a non-focused, or defocused, position of the propagating laser processing bursts 124, such as within one, two, or five Rayleigh ranges of a focused position. The laser processing bursts 124 can be scanned at a scan rate along a scan path 134 to produce black marks in one or more areas 136 of the target surface 126.

The target surface 126 is typically an anodized aluminum or other anodized metallic surface that has a thin anodized layer, typically in the range a few nm to a few tens of nm thick, formed on an underlying bare metallic substrate. The laser processing bursts 124 received by the target surface 126 produce dark laser marks on the target surface 126, with an L value (i.e., the lightness component of the standard L*a*b* color space) of less than or equal to 30, without damaging or ablating the anodized layer and with a takt time, or processing speed, superior to conventional laser methods so that such laser marking is feasible in high volume manufacturing. In some examples, an L value of less than or equal to 25 is produced. The laser marking system 100 can also include one or more detectors 138 that are situated to detect an L value associated with the laser marks in the one or more areas 136 on the target surface 126. The detector 138 can be coupled to the controller 114 to provide the L value data so that various characteristics of the laser processing bursts 124 can be adjusted, including quantity of intra-burst pulses (e.g, from 2 to 30 intra-burst pulses or more), temporal spacing between intra-burst pulses (e.g., from less than 1 ns to 20 ns, 50 ns, or more), pulse burst frequency, and/or scan rate, so that the L value of the laser mark can be reduced (i.e., made darker) below the detected value.

In one embodiment, the laser marking system 100 produces laser processing bursts 124 at a pulse burst repetition rate (i.e., pulse burst frequency) of 200 kHz with each laser processing burst 124 having ten intra-burst pulses, each intra-burst pulse with a 50 ps pulse duration, that are temporally spaced from each other, center-to-center, by 20 ns. The processing speed is rapid compared to processing with single picosecond pulses separated by significant repetition rate period durations (e.g., 200 kHz). Scan rates of 5 m/s can be used to scan the laser processing bursts 124 across the target surface 126. The intra-burst pulses can be defocused to have a spot size of 100 μm and a circularly symmetric Gaussian single-mode (M²<1.5) intensity distribution. A corresponding laser mark with an L darkness value of 27.9 was achieved. One or more scan passes of the laser processing bursts can be performed using different scan line spacings, such as 5 μm, 10 μm, 20 μm, or more. Various processing parameters can be adjusted to further improve laser marking performance. In some examples, pulse burst repetition rates include 20 kHz or greater, 50 kHz or greater, 100 kHz or greater, or faster.

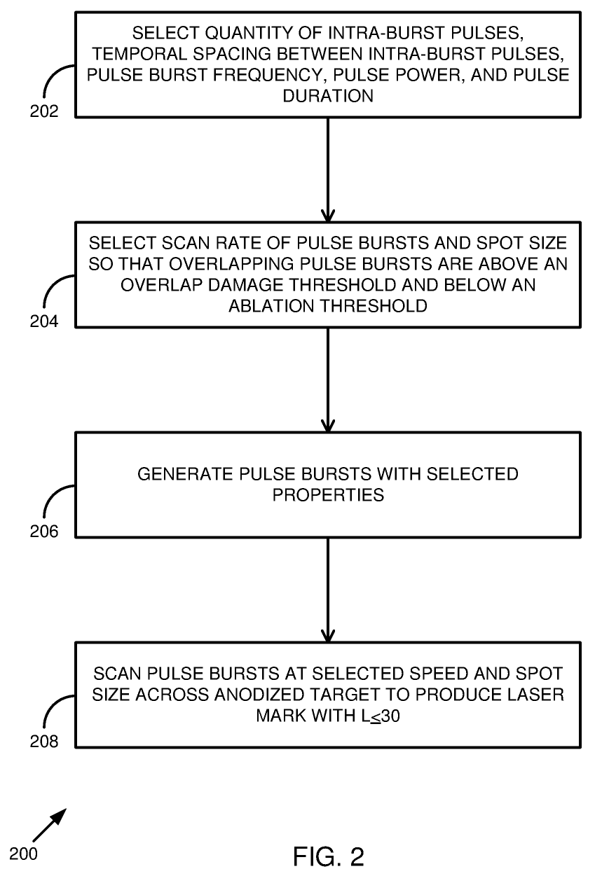

Referring to FIG. 2, an example method 200 includes at a method act 202, selecting a quantity of intra-burst pulses, a temporal spacing between intra-burst pulses, a pulse burst frequency, a pulse power, and a pulse duration for laser pulse bursts and corresponding intra-burst pulses within the laser pulse bursts. At a method act 204, a scan rate and spot size are selected for the laser pulse bursts in relation to a surface of an anodized target. The spot size is selected for a first laser pulse burst and a second laser pulse burst immediately subsequent to the first laser pulse burst. The spot size provides the laser pulse bursts at the surface with a predetermined peak fluence and peak power that are below an ablation threshold. Peak powers and peak fluences above the ablation threshold produce an ablation damage to the anodized layer or underlying substrate at the surface resulting in an undesirable tactile or visible appearance instead of a smooth dark laser mark. The scan rate is selected so that the second laser pulse burst overlaps the first laser pulse burst by an amount that is outside of an overlap damage threshold. Insufficient overlap amounts, e.g., below the overlap damage threshold, can produce damage to the surface, including the formation of microcracks, and various undesirable visible features, such as discoloration or color variation, insufficient darkness, and angular L*a*b* dependence. Laser pulse burst overlaps above the overlap damage threshold produce laser marks with no damage or minimum damage associated with damage induced by mark-to-mark or burst-to-burst proximity.

At a method act 206, laser pulse bursts are generated with the selected properties by a pulsed fiber laser. The generated laser pulse bursts are then scanned, at a method act 208, at the selected scan rate and spot size across the anodized target so as to produce one or more laser marks with an L* value that is less than or equal to 30. In representative examples, the scan rate is faster than a nominal scan rate associated with a single picosecond or nanosecond pulse that is delivered at the pulse burst repetition rate (e.g., one pulse per burst) and that is provided with a pulse-to-pulse overlap above an overlap damage threshold so as to prevent overlap related damage. The scan rate increase above a nominal scan rate can be realized as the intra-burst pulses of the pulse bursts are delivered with a temporal spacing between intra-burst pulses that produces an intra-burst pulse to intra-burst pulse overlap above an overlap damage threshold and that extends the length of the marked area delivered by a pulse burst. For example, the extended marked area associated with a first pulse burst initiated at a first intra-burst pulse position of the first pulse burst allows a second subsequent pulse burst to be delivered with a first intra-burst pulse position of the second pulse burst at a more distant position in relation to the first intra-burst pulse of the first pulse burst, while maintaining sufficient overlap above an overlap damage threshold. In some example laser marking processes, a scan rate increase of 0.5%, 1%, 5%, or more can be achieved over a nominal scan rate with other pulse features kept constant, such as pulse duration and peak power, leading to an improvement in takt time for the laser marking processes.

In some examples, the temporal spacing between a first and second intra-burst pulses is selected to be at least a minimum material relaxation time so as to allow the target sufficient time to relax to a fresh, but marked or partially marked, state after receiving the first intra-burst pulse and before receiving the second subsequent intra-burst pulse in the same area as or a substantial portion of the area of the first intra-burst pulse. By allowing a minimum material relaxation time between intra-burst pulses, an area marked by a pulse burst can be further extended so as to provide scan rate increase. Material relaxation time can vary depending on process parameters and also vary within a pulse burst as a material does not fully relax between intra-burst pulses. Also, relaxation time can change as the marked area becomes increasingly processed by successive intra-burst pulses, either within a pulse burst or due to multiple passes of pulse bursts in the same area. In some examples, the temporal spacing between intra-burst pulses is varied to accommodate a change in material relaxation time during a pulse burst or after successive passes of pulse bursts. For example, a first scan pass of beam of pulses across a target area can include a first temporal spacing between intra-burst pulses and a second scan pass of the target area can have a second temporal spacing longer than the first temporal spacing. In some embodiments, a pulse burst can include three or more intra-burst pulses with a temporal spacing between a first and second intra-burst pulses that is shorter than a temporal spacing between the second and a third intra-burst pulses.

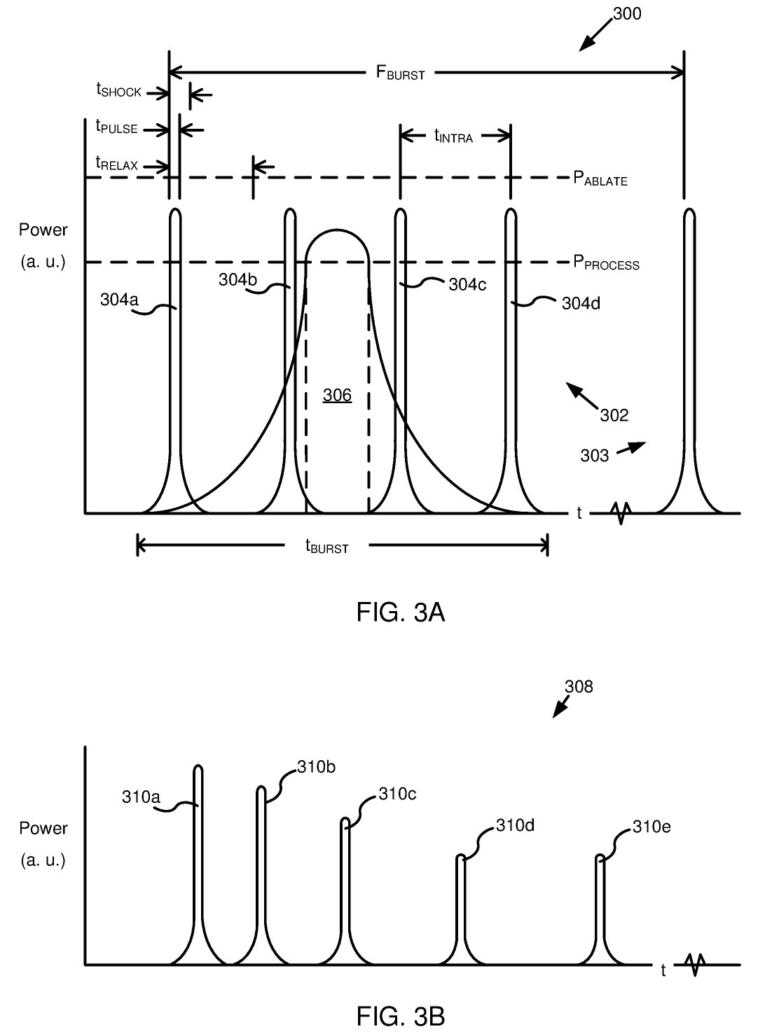

FIG. 3 is a graph 300 of pulse burst 302, 303 having a pulse burst duration t_{BURST}. The pulse burst 302 includes four intra-burst pulses 304a-304d separated from each other by a temporal spacing t_{INTRA}. The intra-burst pulses 304a-304d have a pulse duration t_{PULSE} that is selected so that it is below a material shock threshold t_{SHOCK} which varies from material to material, though for laser marking purposes is generally below a few hundred picoseconds. Suitable pulse durations below t_{SHOCK} include pulse durations t_{PULSE} in the range of 40-60 picoseconds or shorter. By maintaining pulse duration t_{PULSE} below the material shock threshold t_{SHOCK} laser marks with improved darkness can be achieved as compared to laser marks created with pulses with pulse durations above the material shock threshold t_{SHOCK}. For example, an optical pulse 306 of several hundred picoseconds, i.e., closer to the nanosecond regime, is shown for comparison. In addition to having a pulse duration exceeding the material shock threshold t_{SHOCK}, a significant amount of optical energy lies within the tails of the optical pulse 306 that also exceeds the material shock threshold t_{SHOCK} and that further contributes to poor laser marking process performance. The intra-burst pulses are delivered to a laser marking target with a peak power or peak fluence that is above a laser process threshold P_{PROCESS} but below an ablation threshold P_{ABLATE}. The corresponding intra-burst pulses 304a-304d within this window laser and delivered at a pulse burst frequency F_{BURST} process the target so as to produce dark marks with an L* value less than or equal to 30.

As described above, the pulse bursts 302, 303 are spaced apart so as to form a series of pulse bursts repeated at a pulse burst frequency F_{BURST}, or pulse burst repetition rate, and the pulse bursts are scanned across the target so as to mark successive areas of the target. In some examples, the temporal spacing t_{INTRA} between at least two adjacent intra-burst pulses can be greater than a material relaxation time t_{RELAX}. By providing multiple intra-burst pulses 304 in the format of pulse bursts 302, with the temporal spacing t_{INTRA} having a sufficient duration to allow for material relaxation and with t_{PULSE} maintained below a material shock threshold t_{SHOCK}, dark laser marks can be created. Additionally, the laser marks can be created efficiently as the temporal spacing t_{INTRA} can increase the area extent in the scan direction of the laser mark created by the pulse burst 302 at the target surface, effectively elongating the laser mark, while maintaining the laser marking process above an overlap damage threshold at an increased scan speed. The material relaxation time t_{RELAX} can also be pulse burst dependent. For example, the t_{RELAX} associated with the intra-burst pulse 304d can be longer than the intra-burst pulse 304a, so that the temporal spacing t_{INTRA} can overcome or come closer to t_{RELAX} later in the pulse burst 302.

FIG. 3B shows an example pulse burst 308 that includes five intra-burst pulses 310a-310e. As shown, the peak power of and the temporal spacing between the intra-burst pulses 310a-310e can be the same or different from each other within the pulse burst 308. As shown, the temporal spacing the intra-burst pulses 310a-310e increases through the duration of the pulse burst 308 and the peak power of the intra-burst pulses 310a-310d decreases. It will be appreciated that various other temporal spacing and peak power variations can be used as well, including a decreasing temporal spacing, a combination of increasing and decreasing temporal spacings, and arbitrary intra-burst pulse peak powers. The temporal spacing and peak powers can be selected in relation to various material characteristics of the target, such as anodized layer thickness, thermal diffusivity, thermal relaxation time, etc.

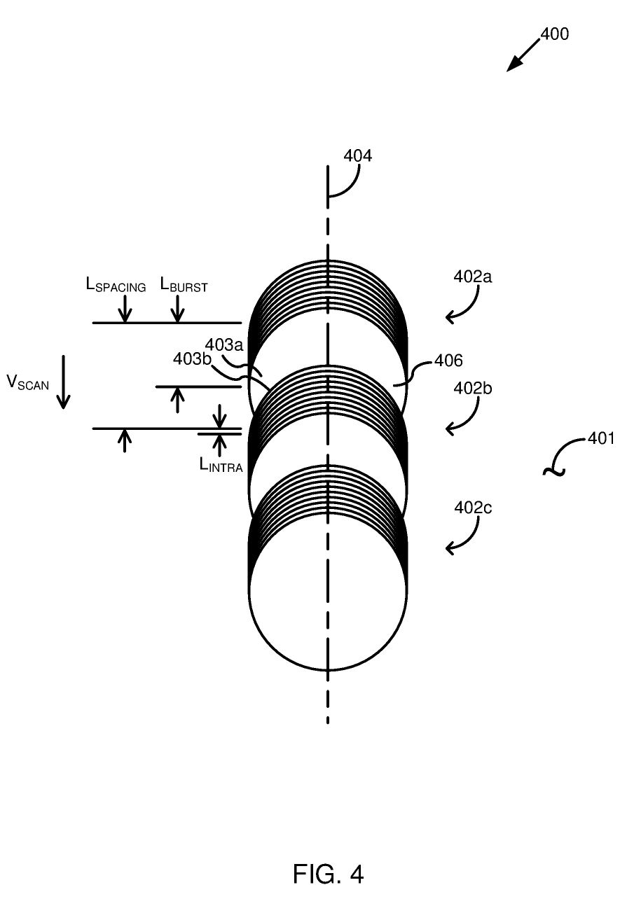

Referring to FIG. 4, a laser mark 400 on an aluminum surface 401 is shown that is formed by three optical pulse bursts corresponding to three sets of circular laser pulse marks 402a, 402b, 402c delivered along a scan path 404 at a predetermined scanning speed v_{SCAN}. Each of the optical pulse bursts includes a packet of ten intra-burst pulses spaced apart from each other in time by a predetermined temporal spacing that is associated with a material relaxation time of the surface 401. The intra-burst pulses interact with the target surface 401 to form corresponding laser marks 406 that are successively spaced from each other by length L_{INTRA} within the set of laser pulse marks 402a. With each successive intra-burst pulse delivered along the scan path 404, a burst length L_{BURST} of the set of marks 402a increases. The optical pulse bursts form a beam and are delivered at a pulse burst frequency that provides a burst to burst spacing L_{SPACING} when divided into the scan speed v_{SCAN}.

Laser marks 406 produced by intra-burst pulses overlap adjacent laser marks 406, including between sets of laser pulse marks 402a-402c such as between an end pulse mark 403a of the set of pulses 402a and the initial pulse mark 403b of the set of pulses 402b. The amount of overlap between pulse marks can be determined based on the characteristics of the optical pulse bursts being delivered, including the aforementioned scan speed v_{SCAN}, pulse burst frequency, intra-burst pulse temporal spacing, pulse size, energy, and intensity profile, etc. In examples herein, the amount of overlap is maintained above an overlap damage threshold below which damage to the surface 401 occurs. The extended length of each the set of laser pulse marks 402a associated with the successive formation of intra-burst pulse marks 406 allows the set of laser pulse marks 402b to be delivered at a spacing L_{SPACING} that has been lengthened by the burst length L_{BURST}. The scan speed v_{SCAN} can be increased, thereby increasing processing speed, to maintain a mark overlap closer to the overlap damage threshold. Alternatively, the scan speed v_{SCAN} can be unaltered and a darker mark can be obtained with fewer scan passes. In some examples, overlap amounts between adjacent pulse marks 406 in a set of pulse marks 402 is 99.9% or greater, 99% or greater, 95% or greater, or 90% or greater, and overlap amounts between adjacent pulse marks 406 of adjacent sets of pulse marks 402a, 402b is 99% or greater, 95% or greater, 90% or greater, or 60% or greater. Overlap amounts are typically dependent on the surface material being marked and the associated overlap damage threshold of the material being marked.

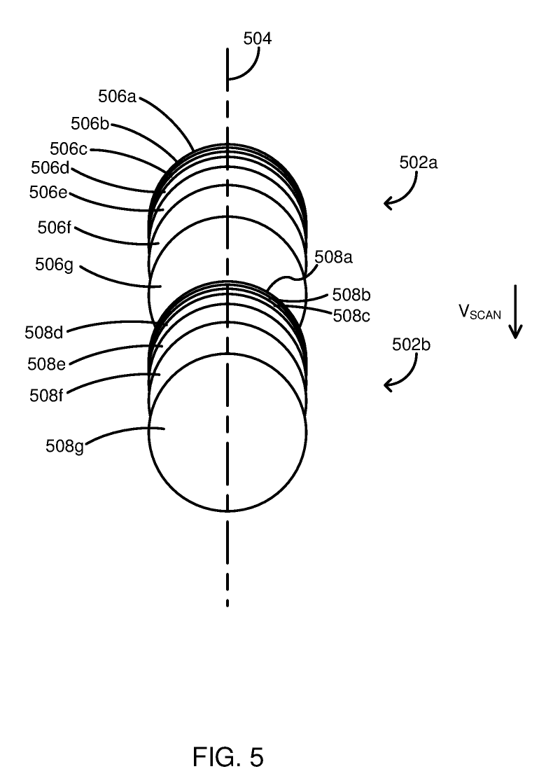

FIG. 5 shows a laser mark 500 on an anodized aluminum surface 501 that is formed by two optical pulse bursts corresponding to three sets of circular laser pulse marks 502a, 502b delivered along a scan path 504 at a predetermined constant scan speed v_{SCAN}. The set of pulse marks 502a includes seven individual pulse marks 506a-506g that adjacently overlap. The pulse marks 506a, 506b overlap each other by a first amount that is relatively large, e.g., 99.9%, and the pulse marks 506b, 506c overlap each other by the about the same amount. The pulse marks 506c, 506d overlap each other by a second amount that is lesser than the first amount, such as 99.8%, and the pulse marks 506d, 506e overlap each other by a third amount, e.g., 99.6%, that is less than the second amount. The pulse marks 506e, 506f overlap each other by a fourth amount, such as 99.2%, that is less than the third amount, and the pulse marks 506f, 506g overlap each other by a fifth amount, e.g., 98.6%, that is less than the fourth amount. The set of pulse marks 502b is similar to the set of pulse marks 502a and includes seven individual pulse marks 508a-508g with corresponding overlap amounts.

The variable and decreasing overlap between adjacent pulse marks 506a-506g of the set of pulse marks 502a and between adjacent pulse marks 508a-508g of the set of pulse marks 502b in the direction of the delivery of the marks, e.g., the direction of the scan speed v_{SCAN}, can improve the darkness of the laser mark 500 formed on the anodized aluminum surface 501 and can allow scan speed v_{SCAN} to be increased. In some examples the scan speed v_{SCAN} is increased and the overlap between the last pulse mark 506g of the set of pulse marks 502a and first pulse mark 508a of the subsequent set of pulse marks 502b is kept constant as compared to pulse marks formed where each set of pulse marks includes one pulse mark. The variability of the overlap within the set of laser pulse marks 502a, 502b can be adjusted to correspond to characteristics of the anodized aluminum surface 501, including in relation to an overlap damage threshold and a thermal relaxation time. In some examples, the variable overlap can increase between adjacent marks in the direction of the delivery of the marks. In further examples, the overlap variability can change one or more times from an increase to a decrease or a decrease to an increase.

In view of the many possible embodiments to which the principles of the disclosed technology may be applied, it should be recognized that the illustrated embodiments are only representative examples and should not be taken as limiting the scope of the disclosure. Alternatives specifically addressed in these sections are merely exemplary and do not constitute all possible alternatives to the embodiments described herein. For instance, various components of systems described herein may be combined in function and use. We therefore claim all that comes within the scope and spirit of the appended claims.

We claim:

1. A method, comprising:
generating a plurality of pulse bursts with a predetermined quantity of intra-burst pulses in each pulse burst and a temporal spacing between the intra-burst pulses, and with a pulse burst frequency; and
scanning the pulse bursts across an anodized target at a scan rate so that the pulse bursts overlap at the anodized target by an amount that is above an overlap damage threshold and the intra-burst pulses provide a peak power and peak fluence that are below an ablation threshold of the anodized target so as to produce a laser mark on the anodized target with an L value of less than or equal to 30 and without a damage to an anodized layer of the anodized target.

2. The method of claim 1, wherein the intra-burst pulse temporal spacing and intra-burst pulse quantity are selected so that an area of the laser mark in a direction of the scanning has an elongated shape.

3. The method of claim 1, wherein the scanning includes providing the pulse bursts with a selected defocus in relation to the anodized target so that the pulse bursts are scanned across the anodized target with a spot size larger than a beam waist associated with the pulse bursts so as to reduce the peak power and peak fluence of the pulse bursts below the ablation threshold.

4. The method of claim 1, wherein the intra-burst pulses have an intra-burst pulse duration that is less than a material shock threshold.

5. The method of claim 4, wherein the intra-burst pulse duration is selected to be in the range of 40 ps to 60 ps.

6. The method of claim 1, wherein a minimum intra-burst temporal spacing is at least a material thermal relaxation time of the anodized target.

7. The method of claim 6, wherein the minimum intra-burst temporal spacing is 10 ns.

8. The method of claim 6, wherein the material thermal relaxation time varies based on a temporal position within each pulse burst.

9. The method of claim 1, further comprising selecting an intra-burst pulse quantity based on a thermal diffusivity of the anodized target.

10. The method of claim 1, wherein the intra-burst pulse quantity is constant and selected in the range from five to fifteen intra-burst pulses.

11. The method of claim 1, wherein at least two of the intra-burst pulses in at least one of the pulse bursts have different selected peak powers.

12. The method of claim 1, wherein the intra-burst pulse temporal spacing is selected to vary within at least one of the pulse bursts.

13. The method of claim 12, wherein the temporal spacing increases between successive pairs of the intra-burst pulses in the at least one pulse burst.

14. The method of claim 1, wherein the pulse burst frequency is 100 kHz or greater.

15. The method of claim 1, wherein a peak power and peak fluence of the intra-burst pulses are greater than a power marking process threshold and a fluence marking process threshold.

16. The method of claim 1, wherein the L value of the laser mark is less than or equal to 25.

17. An anodized aluminum target, made by the process of claim 1.

18. An apparatus, comprising:
a pulsed fiber laser situated to generate the pulse bursts according to claim 1; and
a beam scanning system situated to scan the generated pulse bursts across the anodized target at the scan rate according to claim 1.

19. The apparatus of claim 18, wherein the pulsed fiber laser has a master oscillator power amplifier architecture.

20. The method of claim 1, further comprising detecting an L value associated with an anodized target and adjusting quantity of intra-burst pulses, temporal spacing between intra-burst pulses, pulse burst frequency, and/or scan rate based on the detected L value so as to produce a laser mark with an L value lower than the detected value.
